(19) United States
(12) Patent Application Publication
(10) Pub. No.: US 2025/0164657 A1
(43) Pub. Date: May 22, 2025

(54) METHOD AND APPARATUS FOR DETERMINING VELOCITY OF SUBSURFACE MEDIUM, AND DEVICE

(71) Applicants: China National Petroleum Corporation, Beijing (CN); BGP Inc., China National Petroleum Corporation, Baoding (CN); CPNC Exploration Software Co.,Ltd, Beijing (CN)

(72) Inventors: Xiang LI, Baoding (CN); Zhengzheng ZHOU, Baoding (CN); Jiawen SONG, Baoding (CN); Feng CHEN, Baoding (CN); Lian DUAN, Baoding (CN); Huili HE, Baoding (CN)

(21) Appl. No.: 19/033,034

(22) Filed: Jan. 21, 2025

Related U.S. Application Data
(63) Continuation of application No. PCT/CN2022/138933, filed on Dec. 14, 2022.

(30) Foreign Application Priority Data
Jul. 19, 2022 (CN) 202210848031.7

(51) Int. Cl. G01V 1/28; G01V 1/30

(52) U.S. Cl. CPC G01V 1/282; G01V 1/303; G01V 2210/1212; G01V 2210/1297; G01V 2210/1427; G01V 2210/67

(57) ABSTRACT

A method for determining velocity of a subsurface medium includes: acquiring, by an ocean bottom node, seismic data generated by exciting a monopole source at a shot point; determining a dipole source and a zero-phase monopole source according to the monopole source, and combining the dipole source and the zero-phase monopole source to obtain a directional source; exchanging the position of the ocean bottom node with the position of the shot point and, acquiring, by the exchanged node, synthetic data generated by exciting the directional source at the exchanged shot point; and determining a target velocity model according to an up going wavefiled of the seismic data and the synthetic data.

### CROSS REFERENCE TO RELATED APPLICATIONS

This application is a continuation of International Application No. PCT/CN2022/138933, filed on Dec. 14, 2022, which claims priority to Chinese Patent Application No. 202210848031.7 filed with China National Intellectual Property Administration on Jul. 19, 2022. Both of the aforementioned applications are hereby incorporated by reference in their entireties.

### TECHNICAL FIELD

The present disclosure relates to seismic data processing technology, in particular to a method and an apparatus for determining velocity of subsurface medium, and a device.

### BACKGROUND

Seismic data collection by ocean bottom node (OBN) is a marine seismic acquisition technology that has appeared in recent years. OBN data is a multi-component seismic data which is laid on the seabed and may independently acquire and record seismic signals. OBN may receive the directional information of seismic data. A velocity model of subsurface medium may be determined using the OBN data. The velocity model is then utilized to image the seismic data. The higher the accuracy of the velocity model, the higher the imaging quality of the seismic data.

In the prior art, a monopole source may be excited at a shot point, and seismic data may be acquired using OBN. Then, based on the reciprocity theorem, the positions of the shot point and OBN are exchanged, and a monopole source is excited at the exchanged shot point, and synthetic data is acquired by using the exchanged OBN. Then, by using the up going wavefiled of the seismic data and synthetic data and based on the full waveform inversion (FWI) algorithm, the velocity model of the subsurface medium is determined. However, the accuracy of the velocity model obtained by the above method needs to be further improved.

### SUMMARY

In view of the above problems, the present disclosure provides a method and an apparatus for determining velocity of subsurface medium, and a device.

In a first aspect, the present disclosure provides a method for determining velocity of subsurface medium, including: acquiring, by an ocean bottom node, seismic data generated by exciting a monopole source at a shot point, where the monopole source omnidirectionally radiates energy equally at an excitation moment; determining a dipole source and a zero-phase monopole source according to the monopole source; combining the dipole source and the zero-phase monopole source to obtain a directional source; exchanging a position of the ocean bottom node with a position of the shot point; and acquiring, by using the exchanged ocean bottom node, synthetic data generated by exciting the directional source at the exchanged shot point; and determining a target velocity model according to the synthetic data and an up going wavefiled of the seismic data; where the target velocity model is used to characterize a propagation velocity of a seismic wave in the subsurface medium, and the up going wavefiled represents seismic data acquired from the ocean bottom node. In other implementations, determining the read-only permission result based on a register provided by a fast table, page table, or other memory management mechanism, where the register provided by the fast table, page table, or other memory management mechanism store various permission results for memory pages or memory regions.

In other implementations, the method further includes: determining a first derivative parameter of the monopole source with respect to a vertical direction, and using the first derivative parameter as the dipole source; and determining a second derivative parameter of the monopole source with respect to time, and using the second derivative parameter as the zero-phase monopole source.

In other implementations, the method further includes: repeating the following process until a residual between the up going wavefiled and the synthetic data is less than a first preset threshold or number of iterations reaches a second preset threshold: based on a current velocity model, acquiring, by the exchanged ocean bottom node, synthetic data generated by exciting the directional source at the exchanged shot point; determining the residual between the up going wavefiled and the synthetic data; determining a search direction parameter and a search step length parameter of the current velocity model according to the residual; updating the current velocity model according to the search direction parameter, and the search step length parameter; where a model obtained when the residual is less than the first preset threshold or the number of iterations reaches the second preset threshold is the target velocity model.

In other implementations, the monopole source is a seismic longitudinal source.

In other implementations, the method further includes: displaying the target velocity model to enable a user to check the propagation velocity of the seismic wave in the subsurface medium.

In a second aspect, the present disclosure provides an apparatus for determining velocity of subsurface medium, including: an observation data acquisition unit, configured to acquire by an ocean bottom node seismic data generated by exciting a monopole source at a shot point; where the monopole source omnidirectionally radiates energy equally at an excitation moment; a source determination unit, configured to determine a dipole source and a zero-phase monopole source according to the monopole source; combining the dipole source and the zero-phase monopole source to obtain a directional source; a synthetic data acquisition unit, configured to exchange a position of the ocean bottom node with a position of the shot point; and acquiring, by the exchanged ocean bottom node, synthetic data generated by exciting the directional source at the exchanged shot point; and a velocity determination unit, configured to determine a target velocity model according to the synthetic data and an up going wavefiled of the seismic data; where the target velocity model is used to characterize a propagation velocity of a seismic wave in the subsurface medium, and the up going wavefiled represents seismic data acquired from the ocean bottom node.

In other implementations, the source determination unit is specifically configured to: determine a first derivative parameter of the monopole source with respect to a vertical direction, using the first derivative parameter as the dipole source; and determining a second derivative parameter of the monopole source with respect to time, using the second derivative parameter as the zero-phase monopole source.

In a third aspect, the present disclosure provides an electronic device, including: at least one processor and a memory;
the memory stores computer executable instructions; the at least one processor executes the computer executable instructions stored in the memory, causing the at least one processor performs any one of the methods according to the first aspect.

In a fourth aspect, the present disclosure provides a computer readable storage medium, the computer readable storage medium stores computer executable instructions, which, when executed by a processor, implements any one of the methods according to the first aspect.

In a fifth aspect, the present disclosure provides a computer program product, includes a computer program, which, when executed by a processor, implements any one of the methods according to the first aspect.

The method and apparatus for determining velocity of subsurface medium, and the device, as provided by the present disclosure involve acquiring, by an ocean bottom node, seismic data generated by exciting a monopole source at a shot point where the monopole source omnidirectionally radiates energy equally at an excitation moment; determining a dipole source and a zero-phase monopole source according to the monopole source; combining the dipole source and the zero-phase monopole source to obtain a directional source; exchanging a position of the ocean bottom node with a position of the shot point; and acquiring by using the exchanged ocean bottom node synthetic data generated by exciting the directional source at the exchanged shot point; and determining a target velocity model according to an up going wavefiled of the seismic data and the synthetic data, where the target velocity model is used to characterize a propagation velocity of a seismic wave in the subsurface medium, and the up going wavefiled represents seismic data acquired from the ocean bottom node. That is, the embodiments of the present disclosure may process the monopole source and obtain the directional source with a directional feature, acquire, by using an ocean bottom node, seismic data generated by exciting the directional source at a shot point, and determine the velocity model using the synthetic data and the up going wavefiled separated from the acquired seismic data. In this way, the accuracy of the obtained velocity model may be improved.

### BRIEF DESCRIPTION OF DRAWINGS

FIG. 1 is a flowchart of a method for determining velocity of subsurface medium according to the present disclosure.

FIG. 2 is a wavefield snapshot created by a monopole source according to the present disclosure.

FIG. 3 is a wavefield snapshot created by a dipole source according to the present disclosure.

FIG. 4 is a wavefield snapshot created by a directional source according to the present disclosure.

FIG. 5 is a schematic diagram of up and down going wavefileds of seismic data according to the present disclosure.

FIG. 6 is a schematic diagram of an up going wavefield recording and a down going wavefield recording of seismic data according to the present disclosure.

FIG. 7 is a schematic diagram of a wavefield recording generated by exciting a monopole source at an exchanged shot point according to the present disclosure.

FIG. 8 is a schematic diagram of a wavefield recording generated by exciting a directional source at an exchanged shot point according to the present disclosure.

FIG. 9 is a flowchart of another method for determining velocity of subsurface medium according to the present disclosure.

FIG. 10 is a schematic diagram of a first velocity model when simulating seismic data and an initial velocity model when simulating synthetic data according to the present disclosure.

FIG. 11 is a schematic diagram of velocity models obtained from a monopole source and a directional source respectively according to the present disclosure.

FIG. 12 is a schematic structural diagram of an apparatus for determining velocity of subsurface medium according to the present disclosure.

FIG. 13 is a schematic structural diagram of an electronic device according to the present disclosure.

### DESCRIPTION OF EMBODIMENTS

To make the objectives, technical solutions, and advantages of embodiments of the present disclosure clearer, the following clearly and comprehensively describes the technical solutions in embodiments of the present disclosure with reference to the accompanying drawings in examples of the present disclosure.

Seismic data acquisition by ocean bottom node (OBN) is a marine seismic acquisition technology that has appeared in recent years. OBN data is a multi-component seismic data which is laid on the seabed and may independently collect and record seismic signals. OBN receives the directional information of seismic data. The velocity model of subsurface medium may be determined from OBN data. The velocity model is mainly used to image the seismic data. The higher the accuracy of the obtained velocity model, the higher the imaging quality of the seismic data. In the prior art, a monopole source may be excited at a shot point, and seismic data may be acquired using OBN. Then, based on the reciprocity theorem, the positions of the shot point and OBN are exchanged, and the monopole source is excited at the exchanged shot point, and the synthetic data is acquired by the exchanged OBN. OBN receives the directional information of the seismic data, so that the acquired seismic data may be separated into an up going wavefield and a down going wavefield. Since the down going wavefield undergoes a reflection from the free surface of seawater, the down going wavefield has a smaller offset when penetrating the stratum compared to the up going wavefield. Therefore, a velocity model of the subsurface medium is usually determined by using the up going wavefield and synthetic data and based on the full waveform inversion (FWI) algorithm. However, the accuracy of the velocity model obtained by the above method needs to be further improved.

In view of the above problem, the technical concept of the present disclosure is: acquiring, by using an ocean bottom node, synthetic data generated by exciting a directional source with a directional feature at a shot point, and determining a velocity model by using the synthetic data and an up going wavefield separated from the acquired seismic data. In this way, the accuracy of the velocity model is improved.

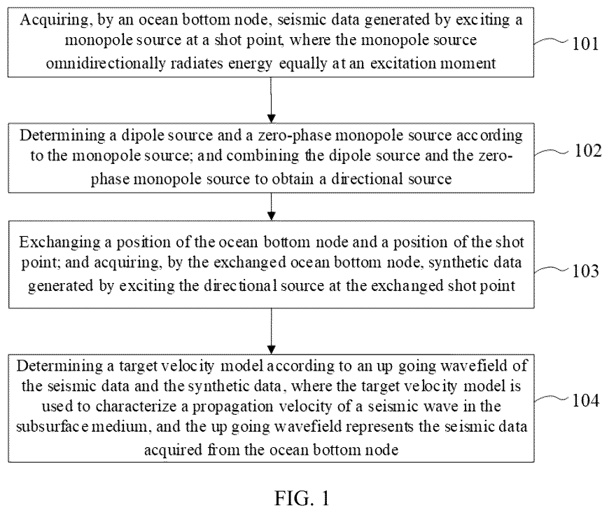

In a first aspect, an embodiment of the present disclosure provides a method for determining velocity of subsurface medium, and FIG. 1 is a flowchart of a method for determining velocity of subsurface medium according to the present disclosure.

As shown in FIG. 1, the method for determining velocity of subsurface medium includes steps below.

Step 101, acquiring, by an ocean bottom node, seismic data generated by exciting a monopole source at a shot point, where the monopole source omnidirectionally radiates energy equally at an excitation moment.

Where the method provided by the present disclosure may be executed by an electronic device with computing capability, such as computer and other devices. The electronic device may obtain the seismic data acquired using the ocean bottom node.

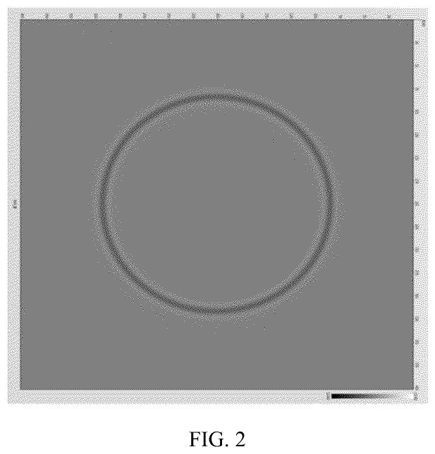

Specifically, shot points may be set at a plurality of positions on sea level, ocean bottom nodes may be set at a plurality of positions of seabed, monopole sources may be sequentially excited at the shot points and seismic data may be acquired by the ocean bottom nodes.

Where seismic data is a seismic wave generated by excitation of the monopole source.

Where the monopole source omnidirectionally radiates energy equally at an excitation moment. FIG. 2 shows a wavefield snapshot created by a monopole source, where both horizontal and vertical coordinates represent positions.

Step 102, determining a dipole source and a zero-phase monopole source according to the monopole source; and combining the dipole source and the zero-phase monopole source to obtain a directional source.

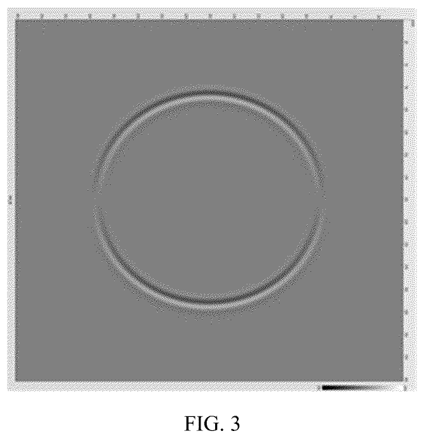

Specifically, the monopole source may be processed to obtain the dipole source. FIG. 3 shows a wavefield snapshot created by a dipole source, where both horizontal and vertical coordinates represent positions. The dipole source is characterized by enhanced longitudinal radiation energy and weakened transversal radiation energy.

Specifically, the monopole source may be processed to obtain the zero-phase monopole source.

Specifically, the obtained dipole source and the obtained zero-phase monopole source may be combined to obtain the directional source.

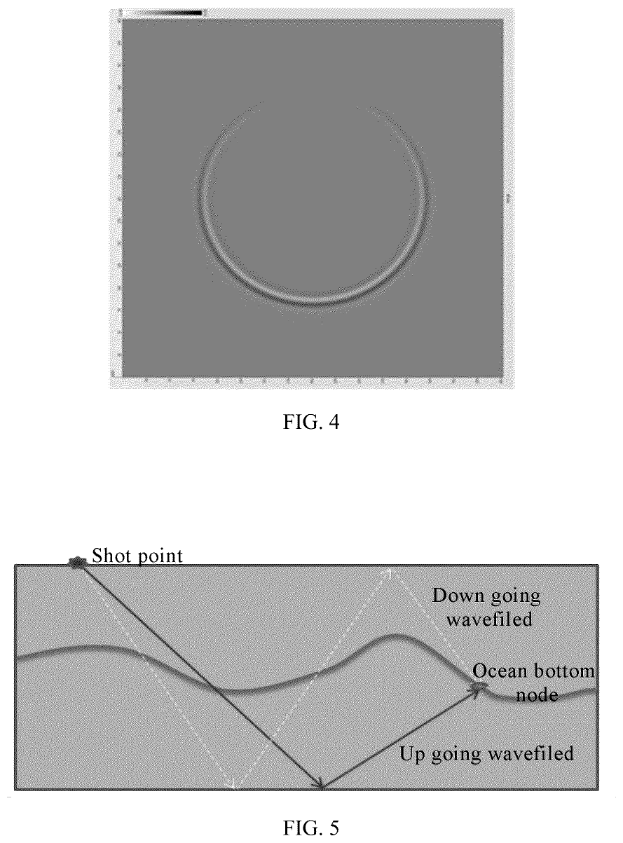

For example, the dipole source and the zero-phase monopole source may be added to obtain the directional source. FIG. 4 shows a wavefield snapshot created by a directional source obtained by adding the dipole source and the zero-phase monopole source, where both horizontal and vertical coordinates represent positions. The directional source has the directional characteristic that the downward radiation energy is enhanced and the upward radiation energy is eliminated. By using this characteristic, the up going wavefiled or down going wavefiled in seismic data may be better matched.

Step 103, exchanging a position of the ocean bottom node and a position of the shot point; and acquiring, by the exchanged ocean bottom node, synthetic data generated by exciting the directional source at the exchanged shot point.

Specifically, the position of the ocean bottom node and the position of the shot point may be exchanged according to the reciprocity theorem. Simulation software may be used to simulate a plurality of exchanged shot points and a plurality of exchanged ocean bottom nodes. Further, exciting the directional sources in sequence at the plurality of exchanged shot points is simulated, and synthetic data is acquired by using the plurality of exchanged ocean bottom nodes, that is, the synthetic data acquired at sea surface, which is generated by excitation of the directional source at a position of the shot point of ocean bottom. For example, the simulation software may be GeoEast software.

Where GeoEast is a unified data platform, a unified display platform, a unified development platform and an integrated software system that can dynamically assemble the system for seismic data processing and interpretation.

Step 104, determining a target velocity model according to an up going wavefield of the seismic data and the synthetic data, where the target velocity model is used to characterize a propagation velocity of a seismic wave in the subsurface medium, and the up going wavefield represents the seismic data acquired from the ocean bottom node.

Specifically, as shown in FIG. 5, the shot point is distributed on the sea surface, and the ocean bottom node is distributed under the sea surface. Seismic data generated by exciting a source at a shot point is acquired by using an ocean bottom node. The seismic data includes an up going wavefield and a down going wavefield. As shown by the dotted path in FIG. 5, the seismic data reflected by the sea surface and acquired above the ocean bottom node is the down going wavefield of the seismic data. Where the down going wavefield may be expressed as d(x, tᵢ), where x represents a position of shot point, tᵢ represents a sampling time, i represents a sampling sequence of ocean bottom node, i=1, 2, 3 . . . n, where n is a total sampling number of single channel data. Where the single channel data refers to sampling data of the ocean bottom node for one shot point.

Similarly, as shown by the solid path in FIG. 5, the seismic data without being reflected by the sea surface and acquired below the ocean bottom node is the up going wavefield of the seismic data. Where the up going wavefield may be expressed as u(x, tᵢ), where x represents a position of shot point, tᵢ represents a sampling time, i represents a sampling sequence of ocean bottom node, i=1, 2, 3 . . . n, where n is a total sampling number of single channel data. Where the single channel data refers to sampling data of the ocean bottom node for one shot point.

Specifically, GeoEast software may be used to separate the up going wavefield from the seismic data.

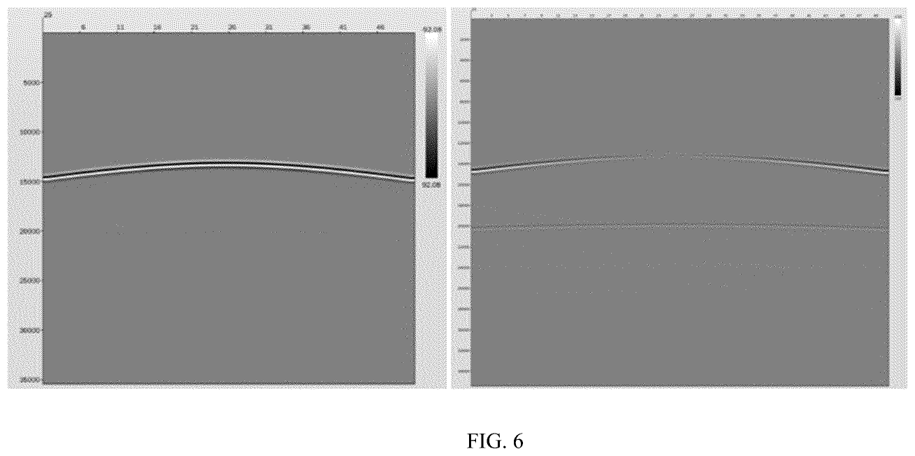

Specifically, the left figure of FIG. 6 shows a wavefield recording of an up going wavefield of seismic data, where the horizontal coordinate represents the a position of shot point and the vertical coordinate represents a sampling time of ocean bottom node. Similarly, the right figure of FIG. 6 shows a wavefield recording of a down going wavefield of seismic data, where the horizontal coordinate represents a position of shot point and the vertical coordinate represents a sampling time of ocean bottom node.

Specifically, FWI may be performed by using the up going wavefield of the seismic data and the synthetic data, thereby obtaining a target velocity model of the propagation velocity of the seismic wave in the subsurface medium.

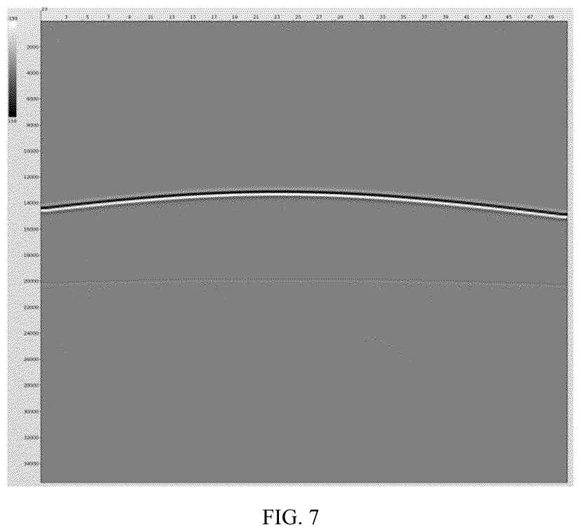

FIG. 7 shows a wavefield recording generated by exciting a monopole source at an exchanged shot point

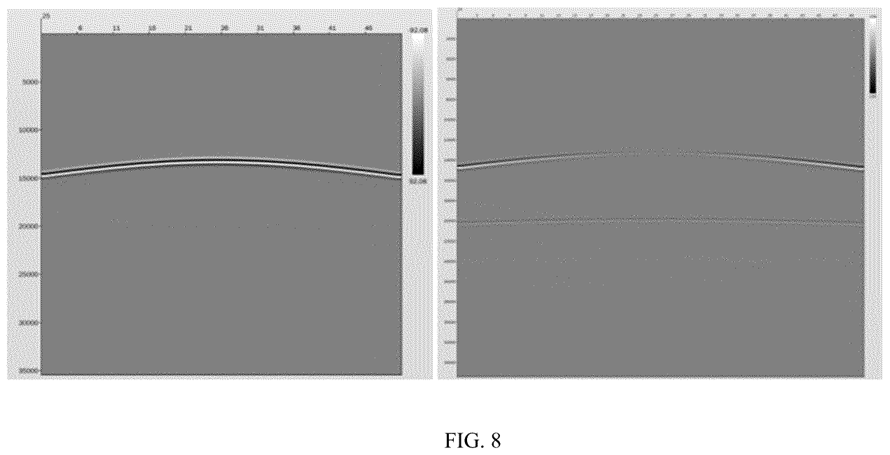

The left figure of FIG. 8 shows a wavefield recording generated by exciting a directional source at an exchanged shot point, where the directional source is obtained by adding the dipole source and the zero-phase monopole source, and where the horizontal coordinate represents a position of the exchanged shot point, the vertical coordinate represents a sampling time of the ocean bottom node.

The right figure of FIG. 8 shows a wavefield recording generated by exciting a directional source at an exchanged shot point, where the directional source is obtained by subtracting the zero-phase monopole source from the dipole source, and where the horizontal coordinate represents a position of the exchanged shot point, and the vertical coordinate represents a sampling time of the ocean bottom node. Specifically, the present solution may obtain the directional source by combining the zero-phase monopole source and the dipole source. By comparing FIG. 6, FIG. 7, and FIG. 8, it can be known that simulating the up and down going wavefields individually by using the directional source as a source may better match the up and down going wavefields recordings than the monopole source.

After obtaining the target velocity model, since the target velocity model characterizes the propagation velocity of the seismic wave in the subsurface medium, the target velocity model may be displayed to facilitate the user to check the propagation velocity of the seismic wave in the subsurface medium. An electronic device may automatically conduct oil and gas exploration according to the target speed model. A user may conduct oil and gas exploration manually according to the target velocity model.

After obtaining the target velocity model, a seismic data image may be generated according to the target velocity model and the seismic data, and then the oil and gas exploration may be conducted automatically or manually according to the seismic data image. The higher the accuracy of the velocity model, the higher the quality of the generated seismic data image, which is more conducive to the oil and gas exploration.

The method for determining velocity of subsurface medium provided by the embodiments of the present disclosure involves acquiring by an ocean bottom node, seismic data generated by exciting a monopole source at a shot point, where the monopole source omnidirectionally radiates energy equally at an excitation moment; determining a dipole source and a zero-phase monopole source according to the monopole source; combining the dipole source and the zero-phase monopole source to obtain a directional source; exchanging a position of the ocean bottom node with a position of the shot point; acquiring by using the exchanged ocean bottom node data generated by exciting the directional source at the exchanged shot point; determining a target velocity model according to an up going wavefield and the synthetic data, where the target velocity model is used to characterize a propagation velocity of a seismic wave in the subsurface medium and the up going wavefield represents seismic data acquired from the ocean bottom node. The embodiments of the present disclosure may process the monopole source and obtain the directional source with a directional feature, acquire by using an ocean bottom node synthetic data generated by exciting the directional source at a shot point, and use the synthetic data and an up going wavefield separated from the acquired seismic data to determine a velocity model. In this way, the accuracy of the velocity model may be improved.

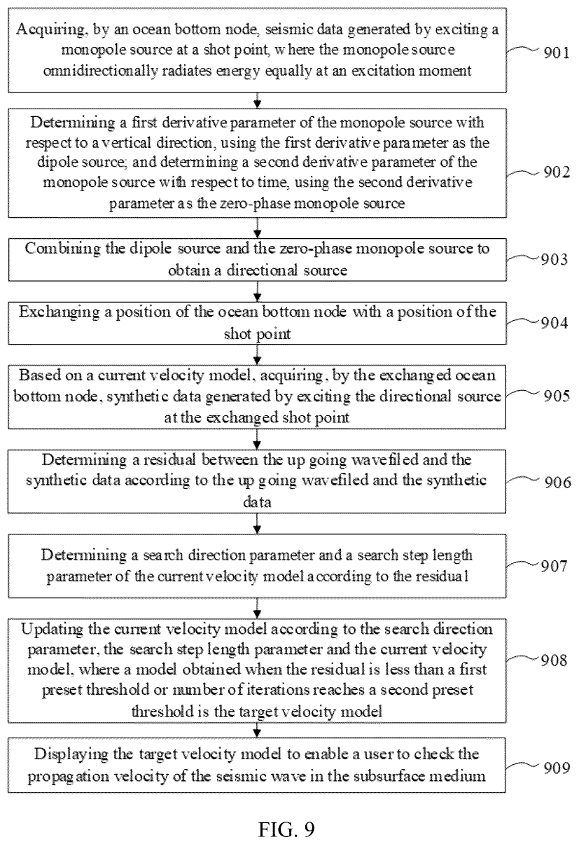

In combination with the foregoing implementations, FIG. 9 is a flowchart of another method for determining velocity of subsurface medium provided by the present disclosure. As shown in FIG. 9, the method for determining velocity of subsurface medium includes steps below.

Step 901, acquiring, by an ocean bottom node, seismic data generated by exciting a monopole source at a shot point, where the monopole source omnidirectionally radiates energy equally at an excitation moment.

Specifically, the principle and implementation of step 901 are similar to those of step 101, and the details are not repeated here.

In an implementation, the monopole source is a seismic longitudinal source.

Step 902, determining a first derivative parameter of the monopole source with respect to a vertical direction, using the first derivative parameter as the dipole source; and determining a second derivative parameter of the monopole source with respect to time, using the second derivative parameter as the zero-phase monopole source.

Specifically, the equation for the first derivative parameter of the monopole source with respect to the vertical direction is as follows:

$$f ( {{x}^{'}}_{0} ) = \frac{f ( {x}_{0} + i z ) - f ( {x}_{0} )}{i z}$$

where f represents a wavefield generated by the monopole source, x₀ represents a position of the wavefield generated by the monopole source, iz represents an increment in z direction, and the z direction represents a vertical direction.

Specifically, the first derivative parameter may be used as the dipole source.

Specifically, the equation for the second derivative parameter of the monopole source with respect to time is as follows:

$${f}_{t} ( {{x}^{'}}_{0} ) = \frac{f ( {x}_{0} + it ) - f ( {x}_{0} )}{it}$$

where f represents a wavefield generated by the monopole source, x₀ represents a position of the wavefield generated by the monopole source, and it represents an increment in time t.

Specifically, the second derivative parameter may be used as the zero-phase monopole source.

Step 903, combining the dipole source and the zero-phase monopole source to obtain a directional source.

Specifically, the present solution does not limit the way of combination of dipole source and the zero-phase monopole source. For example, it is possible to add the dipole source and the zero-phase monopole source; or for them, it is possible to subtract the zero-phase monopole source from the dipole source.

Specifically, the present solution is to obtain the zero-phase monopole source and the dipole source according to a conventional monopole source, which may not only obtain source sources with the same and different energy in different directions in space, but also combine two kinds of sources to form a new source, thus enriching the selection of sources in OBN FWI.

Step 904, exchanging a position of the ocean bottom node with a position of the shot point.

Specifically, the position of the ocean bottom node and the position of the shot point may be exchanged according to the reciprocity theorem.

The following process is repeated until a residual between the up going wavefield and the synthetic data is less than a first preset threshold or number of iterations reaches a second preset threshold:

Step 905, based on a current velocity model, acquiring, by the exchanged ocean bottom node, synthetic data generated by exciting the directional source at the exchanged shot point.

Specifically, a simulation model may be established by using simulation software according to the current velocity model, and a plurality of the exchanged shot points and a plurality of the exchanged ocean bottom nodes may be simulated in the simulation model.

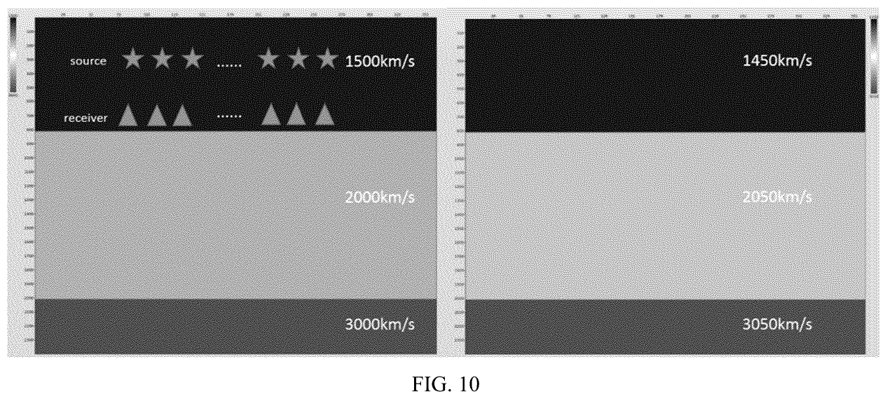

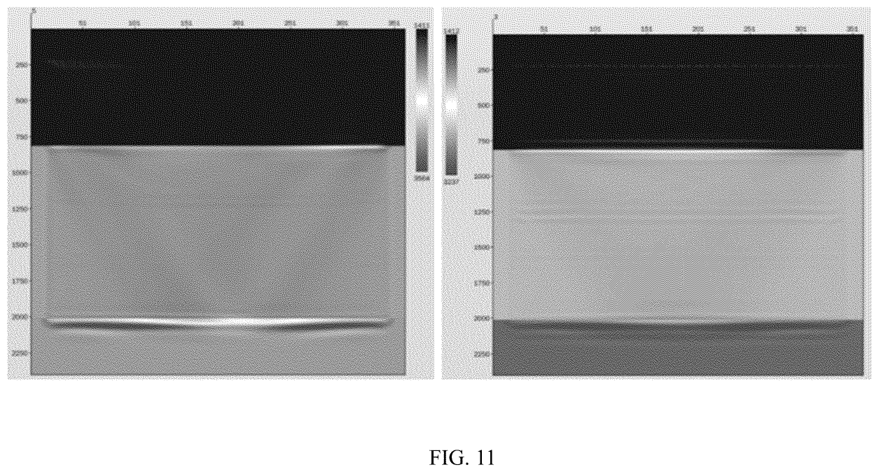

Specifically, in first repetition process, the current velocity model may be a preset initial velocity model. The initial velocity model is a velocity model that is preset based on an actual situation. For example, if the seismic data is obtained by simulating using simulation software, the seismic data may be based on a first velocity model as shown in the left figure of FIG. 10. The first velocity model may be smoothed to obtain an initial velocity model. The obtained initial velocity model is as shown in the right figure of FIG. 10. In the velocity model, both the horizontal and vertical coordinates represent a position.

Specifically, simulation software is used to simulate sequential excitation of the directional sources at a plurality of the exchanged shot points, and the plurality of the exchanged ocean bottom nodes are used to acquire synthetic data.

Step 906, determining a residual between the up going wavefield and the synthetic data according to the up going wavefield and the synthetic data.

Specifically, FWI may be performed using the up going wavefield of the seismic data and the synthetic data.

Firstly, an objective function is constructed according to the up going wavefield of the seismic data and the synthetic data, thereby determining the residual between the up going wavefield of the seismic data and the synthetic data.

Where the equation of the constructed objective function is as follows:

$$min ∅ ( m ) = p ( D - F ( m ) )$$

where min Ø(m) represents the residual between the up going wavefield of the seismic data and the synthetic data, m represents a current velocity model, prepresents an expression of the objective function, D represents the up going wavefield of the seismic data, and F(m) represents the synthetic data obtained based on the current velocity model.

Step 907, determining a search direction parameter and a search step length parameter of the current velocity model according to the residual.

Specifically, by taking derivatives of the velocity based on the constructed objective function, the gradient of the current velocity model may be obtained, thereby the search direction parameter and the search step length parameter of the current velocity model may be obtained.

Step 908, updating the current velocity model according to the search direction parameter, the search step length parameter and the current velocity model, where a model obtained when the residual is less than a first preset threshold or number of iterations reaches a second preset threshold is the target velocity model.

Specifically, an update function may be constructed based on the search direction parameter, the search step length parameter, and the current velocity model to update the current velocity model. The update function is as follows:

$${m}_{k + 1} = {m}_{k} + {α}_{k} {s}_{k}$$

where mₖ represents the current velocity model, αₖ represents the search direction parameter of the current velocity model, sₖ represents the search step length parameter of the current velocity model, and mₖ₊₁ represents the updated velocity model.

Specifically, if it is determined that the residual between the up going wavefield of the seismic data and the synthetic data is larger than the first preset threshold and do not reach the second preset threshold number of iterations, the updated velocity model would be used as the current velocity model of the next repetition process, to continue performing step 705 until it is determined that the residual is less than the first preset threshold or the number of iterations reaches the second preset threshold, then, the repetition process is ended and the velocity model obtained at this time is determined as the target velocity model.

Specifically, the right figure of FIG. 11 shows a target velocity model obtained by inversion according to collected seismic synthetic data generated by exciting a directional source, where the horizontal coordinate represents a spatial position, the vertical coordinate represents a seawater depth, and different colors represent different velocity values.

Specifically, the left figure of FIG. 11 shows a velocity model obtained according to collected synthetic data generated by exciting a monopole source, where the horizontal coordinate represents a spatial position, the vertical coordinate represents a seawater depth, and different colors represent different velocity values.

Specifically, by comparing the collected synthetic data generated by exciting the monopole source and the collected synthetic data generated by exciting the directional source, a large number of multiple waves exist in the synthetic data acquired by exciting the monopole source.

By comparing the left and right figures in FIG. 10, it can be seen that the inversion result obtained according to the directional source shows a more accurate result on the velocity interface.

Specifically, the present solution uses the reciprocity theorem to exchange the position of sea surface shot points with ocean bottom nodes in OBN data to perform FWI inversion of the directional source. It is possible to separately invert up going wavefield data, to obtain a more accurate update amount of the velocity model compared to the monopole source FWI and thus obtain a more accurate velocity model.

Step 909, displaying the target velocity model to enable a user to check the propagation velocity of the seismic wave in the subsurface medium.

Specifically, the target velocity model may be displayed by simulation software to enable the user to check the propagation velocity of the seismic wave in the subsurface medium.

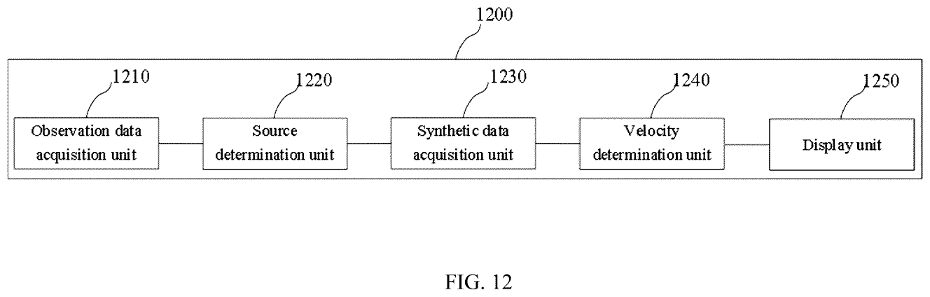

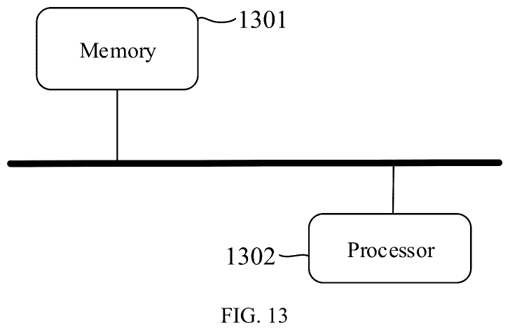

In a second aspect, the present disclosure exemplarily provides an apparatus for determining velocity of subsurface medium. FIG. 12 is a schematic structural diagram of an apparatus for determining velocity of subsurface medium according to the present disclosure. As shown in FIG. 12, the apparatus for determining velocity of subsurface medium 1200 includes:
an observation data acquisition unit 1210, configured to acquire by an ocean bottom node seismic data generated by exciting a monopole source at a shot point, where the monopole source omnidirectionally radiates energy equally at an excitation moment;
a source determination unit 1220, configured to determine a dipole source and a zero-phase monopole source according to the monopole source, and combining the dipole source and the zero-phase monopole source to obtain a directional source;
a synthetic data acquisition unit 1230, configured to exchange a position of the ocean bottom node with a position of the shot point, and acquire by the exchanged ocean bottom node synthetic data generated by exciting the directional source at the exchanged shot point; and
a velocity determination unit 1240, configured to determine a target velocity model according to the synthetic data and an up going wavefiled of the seismic data, where the target velocity model is used to characterize a propagation velocity of a seismic wave in the subsurface medium, and the up going wavefield represents the seismic data acquired from the ocean bottom node.

The source determination unit 1220 is specifically configured to determine a first derivative parameter of the monopole source with respect to a vertical direction, using the first derivative parameter as the dipole source; and
determine a second derivative parameter of the monopole source with respect to time, using the second derivative parameter as the zero-phase monopole source.

The velocity determination unit 1240 is specifically configured to repeat the following process until a residual between the up going wavefield and the synthetic data is less than a first preset threshold or number of iterations reaches a second preset threshold:
based on a current velocity model, acquiring, by the exchanged ocean bottom node, synthetic data generated by exciting the directional source at the exchanged shot point;
determining the residual between the up going wavefield and the synthetic data according to the up going wavefield and the synthetic data;
determining a search direction parameter and a search step length parameter of the current velocity model according to the residual; and
updating the current velocity model according to the search direction parameter, the search step length parameter and the current velocity model;
where a model obtained when the residual is less than the first preset threshold or the number of iterations reaches the second preset threshold is the target velocity model.

In an implementation, the monopole source is a seismic longitudinal source.

The apparatus for determining velocity of subsurface medium 1200 further includes a display unit 1250 for displaying the target velocity model to enable a user to check the propagation velocity of the seismic wave in the subsurface medium.

In a third aspect, the present disclosure exemplarily provides an electronic device. FIG. 13 is a schematic structural diagram of hardware of an electronic device provided by the present disclosure. As shown in FIG. 13, the electronic device includes:
a memory 1301;
a processor 1302; and
a computer program;
where the computer program is stored in the memory 1301 and configured to be executed by the processor 1302 to implement any one of the foregoing methods for determining velocity of subsurface medium.

In a fourth aspect, the present disclosure further provides a computer readable storage medium, where the computer readable storage medium stores a computer program, which, when executed by a processor, implements any one of the foregoing methods for determining velocity of subsurface medium.

In a fifth aspect, the present disclosure further provides a computer program product, including a computer program, which, when executed by a processor, implements any one of the foregoing methods for determining velocity of subsurface medium.

It may be understand by those skilled in the art: all or some of the steps for implementing the foregoing method embodiments may be completed through hardware related to program instructions. The foregoing program may be stored in a computer readable storage medium. When the program is executed, it includes executing the steps of the foregoing method embodiments. The foregoing storage medium includes various medium that may store program codes, such as Read-Only Memory (ROM), Random Access Memory (RAM), magnetic disks, or optical disks.

Finally, it should be noted that the foregoing embodiments are merely intended for describing the technical solutions of the present disclosure other than limiting the present disclosure. Although the present disclosure is described in detail with reference to the foregoing embodiments, persons of ordinary skill in the art should understand that they may still make modifications to the technical solutions described in the foregoing embodiments or make equivalent substitutions to some or all technical features therein; and these modifications or substitutions do not make the essence of the corresponding technical solutions depart from the scope of the technical solutions of various embodiments of the present disclosure.

What is claimed is:

1. A method for determining velocity of subsurface medium, comprising:
acquiring, by an ocean bottom node, seismic data generated by exciting a monopole source at a shot point, wherein the monopole source omnidirectionally radiates energy equally at an excitation moment;
determining a dipole source and a zero-phase monopole source according to the monopole source, and combining the dipole source and the zero-phase monopole source to obtain a directional sub-wave;
exchanging a position of the ocean bottom node with a position of the shot point, and acquiring, by the exchanged ocean bottom node, seismic synthetic data generated by exciting the directional sub-wave at the exchanged shot point; and
determining a target velocity model according to an up going wavefiled of the seismic data and the seismic synthetic data, wherein the target velocity model is used to characterize a propagation velocity of a seismic wave in the subsurface medium, and the up going wavefiled represents seismic data acquired from the ocean bottom node.

2. The method according to claim 1, wherein determining the dipole source and the zero-phase monopole source according to the monopole source comprises:
determining a first derivative parameter of the monopole source with respect to a vertical direction, using the first derivative parameter as the dipole source; and
determining a second derivative parameter of the monopole source with respect to time, using the second derivative parameter as the zero-phase monopole source.

3. The method according to claim 1, wherein acquiring, by the exchanged ocean bottom node, the seismic synthetic data generated by exciting the directional sub-wave at the exchanged shot point and determining the target velocity model according to the up going wavefiled of the seismic data and the seismic synthetic data, comprises:
repeating the following process until a residual between the up going wavefield and the seismic synthetic data is less than a first preset threshold or number of iterations reaches a second preset threshold:
based on a current velocity model, acquiring, by the exchanged ocean bottom node, the seismic synthetic data generated by exciting the directional sub-wave at the exchanged shot point;
determining the residual between the up going wavefiled and the seismic synthetic data according to the up going wavefield and the seismic synthetic data;
determining a search direction parameter and a search step length parameter of the current velocity model according to the residual; and
updating the current velocity model according to the search direction parameter, the search step length parameter and the current velocity model;
wherein a model obtained when the residual is less than the first preset threshold or the number of iterations reaches the second preset threshold is the target velocity model.

4. The method according to claim 1, wherein the monopole source is a seismic longitudinal sub-wave.

5. The method according to claim 2, wherein the monopole source is a seismic longitudinal sub-wave.

6. The method according to claim 3, wherein the monopole source is a seismic longitudinal sub-wave.

7. The method according to claim 1, wherein the method further comprises:
displaying the target velocity model to enable a user to check the propagation velocity of the seismic wave in the subsurface medium.

8. The method according to claim 2, wherein the method further comprises:
displaying the target velocity model to enable a user to check the propagation velocity of the seismic wave in the subsurface medium.

9. The method according to claim 3, wherein the method further comprises:
displaying the target velocity model to enable a user to check the propagation velocity of the seismic wave in the subsurface medium.

10. An apparatus for determining velocity of subsurface medium, comprising at least one processor and a memory;
wherein the memory stores computer executable instructions;
the at least one processor executes the computer executable instructions stored in the memory to enable the at least one processor to:
acquire by an ocean bottom node seismic data generated by exciting a monopole source at a shot point, wherein the monopole source omnidirectionally radiates energy equally at an excitation moment;
determine a dipole source and a zero-phase monopole source according to the monopole source, and combine the dipole source and the zero-phase monopole source to obtain a directional sub-wave;
exchange a position of the ocean bottom node with a position of the shot point, and acquire, by the exchanged ocean bottom node, seismic synthetic data generated by exciting the directional sub-wave at the exchanged shot point; and
determine a target velocity model according to an up going wavefiled of the seismic data and the seismic synthetic data, wherein the target velocity model is used to characterize a propagation velocity of a seismic wave in the subsurface medium, and the up going wavefiled represents seismic data acquired from the ocean bottom node.

11. The apparatus according to claim 10, wherein the at least one processor is further enabled to:
determine a first derivative parameter of the monopole source with respect to a vertical direction, using the first derivative parameter as the dipole source; and
determine a second derivative parameter of the monopole source with respect to time, using the second derivative parameter as the zero-phase monopole source.

12. The apparatus according to claim 10, wherein the at least one processor is further enabled to:
repeat the following process until a residual between the up going wavefield and the seismic synthetic data is less than a first preset threshold or number of iterations reaches a second preset threshold:
based on a current velocity model, acquiring, by the exchanged ocean bottom node, the seismic synthetic data generated by exciting the directional sub-wave at the exchanged shot point;
determine the residual between the up going wavefiled and the seismic synthetic data according to the up going wavefield and the seismic synthetic data;
determine a search direction parameter and a search step length parameter of the current velocity model according to the residual; and
update the current velocity model according to the search direction parameter, the search step length parameter and the current velocity model;
wherein a model obtained when the residual is less than the first preset threshold or the number of iterations reaches the second preset threshold is the target velocity model.

13. The apparatus according to claim 10, wherein the monopole source is a seismic longitudinal sub-wave.

14. The apparatus according to claim 10, wherein the at least one processor is further enabled to:
display the target velocity model to enable a user to check the propagation velocity of the seismic wave in the subsurface medium.

15. A non-transitory computer readable storage medium, wherein the computer readable storage medium stores computer executable instructions, which, when executed by a processor, implements the following:
acquiring, by an ocean bottom node, seismic data generated by exciting a monopole source at a shot point, wherein the monopole source omnidirectionally radiates energy equally at an excitation moment;
determining a dipole source and a zero-phase monopole source according to the monopole source, and combining the dipole source and the zero-phase monopole source to obtain a directional sub-wave;
exchanging a position of the ocean bottom node with a position of the shot point, and acquiring, by the exchanged ocean bottom node, seismic synthetic data generated by exciting the directional sub-wave at the exchanged shot point; and
determining a target velocity model according to an up going wavefiled of the seismic data and the seismic synthetic data, wherein the target velocity model is used to characterize a propagation velocity of a seismic wave in the subsurface medium, and the up going wavefiled represents seismic data acquired from the ocean bottom node.

16. The storage medium according to claim 15, wherein when determining the dipole source and the zero-phase monopole source according to the monopole source, the instructions further implement the following:
determining a first derivative parameter of the monopole source with respect to a vertical direction, using the first derivative parameter as the dipole source; and
determining a second derivative parameter of the monopole source with respect to time, using the second derivative parameter as the zero-phase monopole source.

17. The storage medium according to claim 15, wherein when acquiring, by the exchanged ocean bottom node, the seismic synthetic data generated by exciting the directional sub-wave at the exchanged shot point and determining the target velocity model according to the up going wavefiled of the seismic data and the seismic synthetic data, the instructions further implement the following:
repeating the following process until a residual between the up going wavefield and the seismic synthetic data is less than a first preset threshold or number of iterations reaches a second preset threshold:
based on a current velocity model, acquiring, by the exchanged ocean bottom node, the seismic synthetic data generated by exciting the directional sub-wave at the exchanged shot point;
determining the residual between the up going wavefiled and the seismic synthetic data according to the up going wavefield and the seismic synthetic data;
determining a search direction parameter and a search step length parameter of the current velocity model according to the residual; and
updating the current velocity model according to the search direction parameter, the search step length parameter and the current velocity model;
wherein a model obtained when the residual is less than the first preset threshold or the number of iterations reaches the second preset threshold is the target velocity model.

18. The storage medium according to claim 15, wherein the monopole source is a seismic longitudinal sub-wave.

19. The storage medium according to claim 15, wherein the instructions further implement the following:
displaying the target velocity model to enable a user to check the propagation velocity of the seismic wave in the subsurface medium.

20. A computer program product, comprising a computer program, which, when executed by a processor, implements the method according to claim 1.
